(19) United States
(12) Patent Application Publication
(10) Pub. No.: US 2018/0141373 A1
(43) Pub. Date: May 24, 2018

(54) PAINT SAVER DEVICE AND METHOD

(71) Applicant: Andrew Iddon, Maple Ridge (CA)

(72) Inventor: Andrew Iddon, Maple Ridge (CA)

(21) Appl. No.: 15/355,756

(22) Filed: Nov. 18, 2016

(51) Int. Cl. B44D 3/12; B65D 43/02; B65D 21/02

(52) U.S. Cl. CPC B44D 3/127; B65D 43/0218; B65D 2543/00518; B44D 3/128; B65D 21/0217

(57) ABSTRACT

A paint saver device; a paint can rim cover defined by a semi-rigid composite body having a circular U-shaped cross-section configuration includes an outer-internal-vertical-wall for directing paint spillage into the paint can and includes the outer-external-vertical-wall to provide vertical stability for stacked the paint cans via the external-vertical-wall-extension and a top outer surface peripheral retention barrier situated to prevent relative movement between stacked paint cans. The paint saver device is structured and arranged to provide dual purpose retaining means for the paint can rim cover and biasingly fits over and about a paint-can-lid-channel.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of painting and more specifically relates to paint can rim covers, entitled “The Paint Saver”.

### 2. DESCRIPTION OF RELATED ART

Most cans are right circular cylinders with identical and parallel round tops and bottoms with vertical sides. The fabrication of most cans results in at least one “rim”, a narrow ring whose outside diameter is slightly larger than that of the rest of the can. The flat surfaces of rimmed cans are recessed from the edge of any rim (toward the middle of the can) by about the width of the rim; the inside diameter of a rim, adjacent to this recessed surface, is slightly smaller than the inside diameter of the rest of the can. Some cans have a separate cover that slides onto the top or sometimes may be hinged.

Paint cans in particular are generally constructed using what is known as a double friction cover closure. Paint cans often have a removable plug on the top for access and for reclosing. This type of closure is provided by the joining of a lid (plug) having a positive edge and the can having a negative receiver channel meaning an extremely tight fit between the pieces must be accomplished to prevent leakage.

Generally once a can of paint is opened and the paint is poured into a paint tray, or a user dips a paint brush into a can of paint, the negative receiver channel becomes filled with excess paint and the paint runs down the outside of the can causing the sealing properties of the lid to be diminished while at the same time creating a wasteful mess on the exterior of the can. Further, due to standard construction of paint cans if stacked one on top of the other the cans become very unstable which is not desirable.

Many attempts to solve these inherent problems can be found in the known art of paint can rim covers as shown in U.S. Pat. No. 5,161,689 to John E. Balson which relates to a rim seal for paint can lid. The described rim seal for paint can lid includes a rim seal for use with containers for paint having an upstanding rim at one end and a groove located radially inwardly of the rim defined in part by an inner terminal edge. The rim seal includes an annular top section disposed generally transversely to the axis of a container and providing a planar support surface when assembled to a container. An inner wall section extends downwardly at an angle from the inner peripheral edge of the top section terminating in a radially inwardly directed rib adapted to overlie and seal with the edge of the container. Also, an angular outer section depending from the outer peripheral edge of the top section includes a radial section defining a ledge, and a lower terminal axially extending wall terminating and having an inwardly directed radial circumferentially extending rib.

### BRIEF SUMMARY OF THE INVENTION

In view of the foregoing disadvantages inherent in the known paint can accessory art, the present disclosure provides a novel paint can rim cover. The general purpose of the present disclosure, which will be described subsequently in greater detail, is to provide a paint saver device.

The present invention relates to a device for covering the channel or groove around the upper perimeter of the paint can, and for specifically keeping this area free from paint dripping into during pouring or use while the paint can has been or is open; this reducing loss of paint while performing the duties of painting. Additionally, the present invention avoids paint from spilling down the side of the can or worse, splattering the paint away from the can while putting the can's lid back on after use.

A paint saver device is disclosed herein; the device comprising a paint can rim cover defined by a semi-rigid composite (or other material in alternate embodiments) body having a circular U-shaped cross-section configuration. The paint saver is preferably defined by an outer-internal-vertical-wall, an outer-external-vertical-wall, an external-vertical-wall-extension, a top-outer-surface, a top-inner-surface, an external-vertical-wall-inner-surface, an internal-vertical-wall-inner-surface forming the U-shaped cross-section configuration. Additionally the device comprises a peripheral retention barrier, an interior bead retainer, an exterior rim engagement lock, an exterior wall drip skirt, and a thumb release tab; wherein the paint saver system comprises the rim cover forming the semi-rigid composite body. The semi-rigid composite body having the circular U-shaped cross-section configuration is structured and arranged to provide dual-purpose retaining means for the paint can rim cover.

The paint saver device is designed to biasingly fit over and about a paint-can-lid-channel; wherein the parameters of the paint can rim cover are defined via the outer-internal-vertical-wall, the outer-external-vertical-wall, and the top-outer-surface, the top-outer-surface opposing the top-inner-surface. The outer-internal-vertical-wall includes the internal-vertical-wall-inner-surface having the interior bead retainer, extruded at its lower end. Further the outer-external-vertical-wall includes the external-vertical-wall-inner-surface having the exterior rim engagement lock, extruded midway and the external vertical wall extension, extending therefrom. The external vertical wall also includes the exterior wall drip skirt, and the thumb release tab, preferably arranged perpendicular and extending outwardly, externally opposing the exterior rim engagement lock.

Referring now to the thumb release tab; the thumb release tab is configured to allow for biasing manipulation of the paint can rim cover. The top-outer-surface includes the peripheral retention barrier, extending vertically and circumferentially about an outer quadrant of the top outer surface; the peripheral retention barrier situated to prevent relative movement between stacked paint cans. As designed, the paint saver is favorably configured to prevent paint-drippage by biasingly covering the paint-can-lid-channel and simultaneously providing stackable vertical storage for the paint cans.

According to another embodiment, a paint saver device is also disclosed herein. The paint saver device includes a paint can rim cover including, a semi-rigid composite body having, a circular U-shaped cross-section configuration, an outer-internal-vertical-wall, an outer-external-vertical-wall, an external-vertical-wall-extension, a top-outer-surface, a top-inner-surface, an external-vertical-wall-inner-surface, an internal-vertical-wall-inner-surface, a peripheral retention barrier, an interior bead retainer, an exterior rim engagement lock, an exterior wall drip skirt, and a thumb release tab.

Further the paint saver system comprises the rim cover forming the semi-rigid composite body; wherein the semi-rigid composite body having the circular U-shaped cross-section configuration is structured and arranged to provide dual purpose retaining means for the paint can rim cover and biasingly fits over and about a paint-can-lid-channel.

The parameters of the paint can rim cover are defined via the outer-internal-vertical-wall, the outer-external-vertical-wall, and the top-outer-surface, the top-outer-surface opposing the top-inner-surface, wherein the outer-internal-vertical-wall includes the internal-vertical-wall-inner-surface having the interior bead retainer, at its lower end. The outer-external-vertical-wall includes the external-vertical-wall-inner-surface having the exterior rim engagement lock, extruded midway and the external vertical wall extension, extending therefrom, also the external vertical wall further includes the exterior wall drip skirt, and the thumb release tab, arranged perpendicular and extending outwardly, externally opposing the exterior rim engagement lock.

A thumb release tab is configured to allow for biasing manipulation of the paint can rim cover; wherein the top-outer-surface includes the peripheral retention barrier, extending vertically and circumferentially about an outer quadrant of the top outer surface. The peripheral retention barrier situated to prevent relative movement between stacked paint cans. In this way paint cans can be efficiently and stably stacked for storage to minimize a relative footprint. This feature also promotes safety during storage which is desirable.

Further the paint saver is favorably configured to prevent paint-drippage by biasingly covering the paint-can-lid-channel and simultaneously providing stackable vertical storage for the paint cans, as mentioned. The semi-rigid composite body is further defined by the circular U-shaped cross-section configuration so as to conform to the paint-can-lid-channel and on a rim of the paint can.

To further describe the circular U-shaped cross-section configuration it includes the outer-external-vertical-wall extension to provide vertical stability for stacked the paint cans. The paint can rim cover is provided as a semi-rigid composite body to provide suitable biasing frictioning means when used to promote positive coupling to the paint can.

According to another embodiment, a method of use for the paint saver device is also disclosed herein. The paint saver device includes a first step, removing a paint can lid, second step pressing the paint saver device onto a top of a paint can, third step dipping a paint brush into paint and feathering off excess the paint on paint saver device while preventing the paint from entering a paint-can-lid-channel, fourth step pulling a thumb release tab and removing the paint saver device, and step five replacing the paint can lid. An optional step five may comprise vertically stacking other paint cans on the paint can. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a paint saver device, constructed and operative according to the teachings of the present disclosure.

FIG. 1 is a perspective view of the paint saver device during an ‘in-use’ condition, according to an embodiment of the disclosure.

FIG. 2 is a top view of the paint saver device of FIG. 1, according to an embodiment of the present disclosure.

FIG. 3 is an in use cross-section view of the paint saver device of FIG. 1, according to an embodiment of the present disclosure.

FIG. 4 is a cross-section view of the paint saver device of FIG. 1, according to an embodiment of the present disclosure.

FIG. 5 is a flow diagram illustrating a method of use for the paint saver device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a paint can rim protecter and more particularly to a paint saver device as used to improve the effective use of paint cans while painting and storing cans.

Generally, the present invention relates to a device for covering the channel (groove) around the upper perimeter of the paint can, and for specifically keeping this area free from paint dripping into during pouring or use while the paint can has been or is open. The present invention reduces loss of paint while performing painting duties. Additionally, the device will avoid paint spilling (dripping) down the side of the can and splattering the paint away from the can while putting the can's lid back on after use. These features increase efficiency during painting processes and minimize waste and mess.

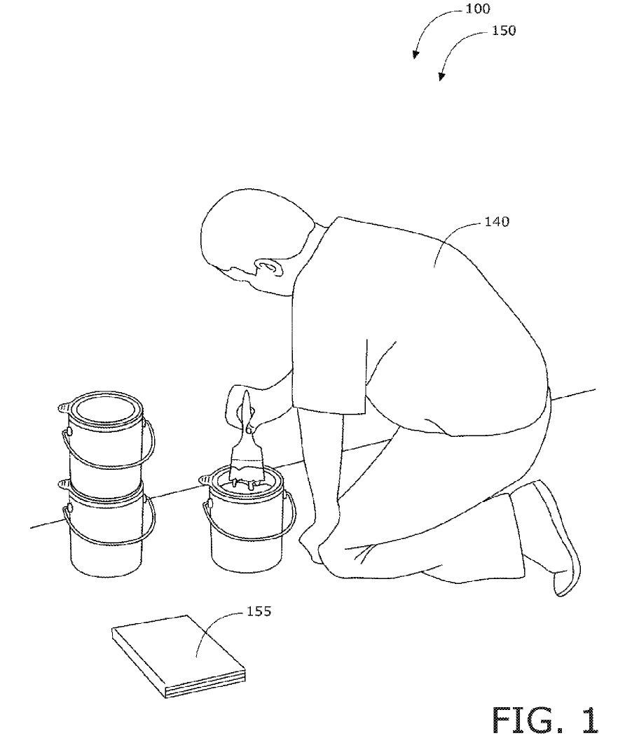

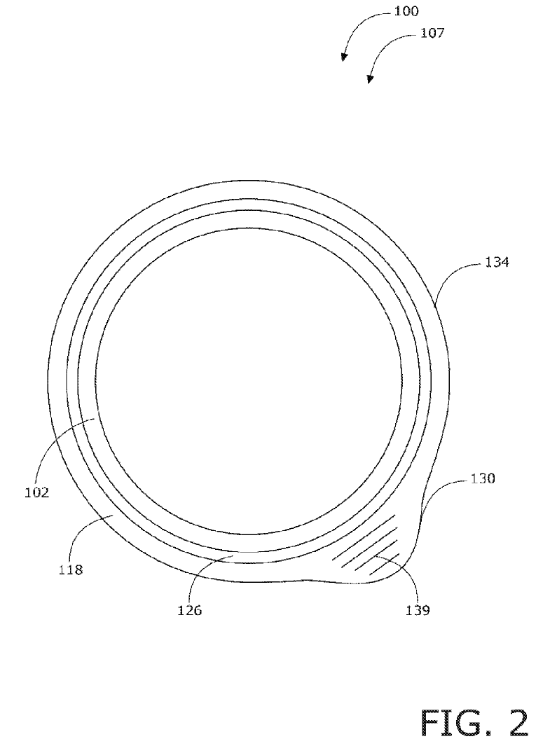

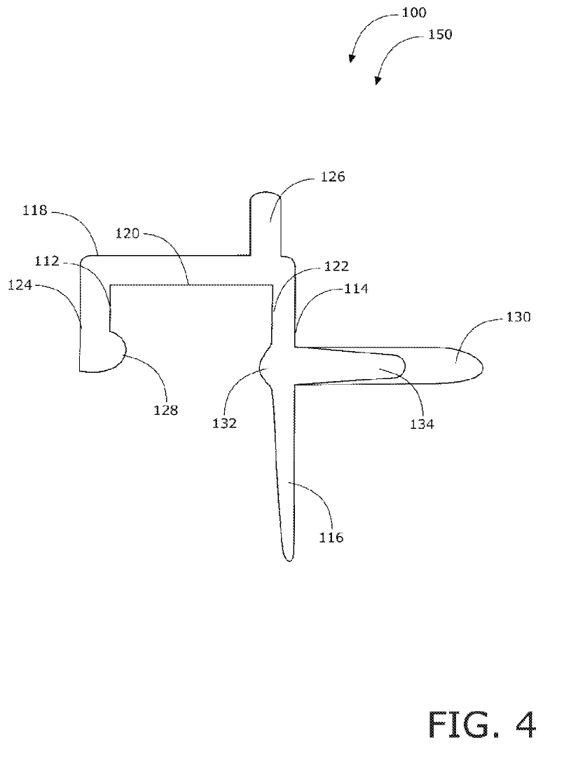

Referring now more specifically to the drawings by numerals of reference, there is shown in FIGS. 1-4, various views of a paint saver device 100. FIG. 1 shows a paint saver device 100 during an ‘in-use’ condition 150, according to an embodiment of the present disclosure. Here, the paint saver device 100 may be beneficial for use by a user 140 to provide a paint can rim cover 102 to essentially prevent paint waste and eliminate paint spillage about the paint-can-lid-channel 110 and exterior of the a paint can 137.

As illustrated, the paint saver device 100 may include a paint can rim cover 102 including a semi-rigid composite body 107 having a circular U-shaped cross-section configuration including, an outer-internal-vertical-wall 112, an outer-external-vertical-wall 114, an external-vertical-wall-extension 116, a top-outer-surface 118, a top-inner-surface 120, an external-vertical-wall-inner-surface 122, an internal-vertical-wall-inner-surface 124, a peripheral retention barrier 126, an interior bead retainer 128, an exterior rim engagement lock 132, an exterior wall drip skirt 134, and a thumb release tab 130.

The paint saver device 100 comprises the paint can rim cover 102 forming the semi-rigid composite body 107; the semi-rigid composite body 107 having the circular U-shaped cross-section configuration structured and arranged to provide dual purpose retaining means for the paint can rim cover 102 and biasingly fits over and about a paint-can-lid-channel 110. The parameters of the paint can rim cover 102 are defined via the outer-internal-vertical-wall 112, the outer-external-vertical-wall 114, and the top-outer-surface 118, the top-outer-surface 118 opposing the top-inner-surface 120, wherein the outer-internal-vertical-wall 112 includes the internal-vertical-wall-inner-surface 124 having the interior bead retainer 128, extruded at its lower end.

Further, the outer-external-vertical-wall 114 includes the external-vertical-wall-inner-surface 122 having the exterior rim engagement lock 132, extruded midway and the external vertical wall extension 116, extending therefrom. Additionally the outer-external-vertical-wall 114 further includes the exterior wall drip skirt 134, and the thumb release tab 130, which may be arranged perpendicular and extending outwardly, and externally opposing the exterior rim engagement lock 132. The thumb release tab 130 is configured to allow for biasing manipulation of the paint can rim cover 102.

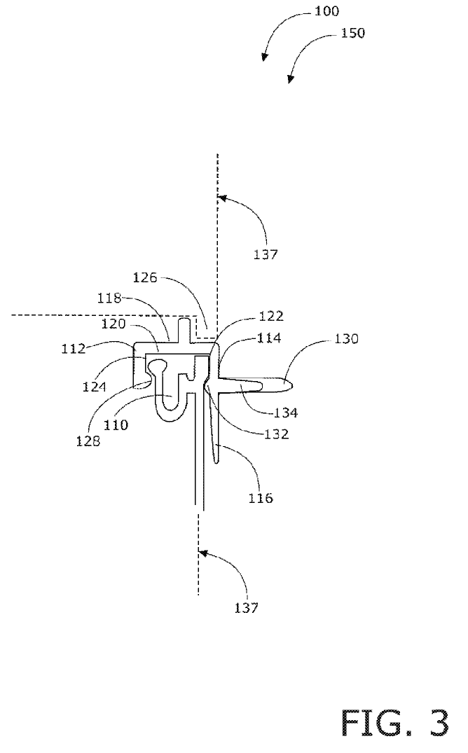

As shown in FIG. 3 the top-outer-surface 118 includes the peripheral retention barrier 126, extending vertically and circumferentially about an outer quadrant of the top outer surface 118, the peripheral retention barrier 126 situated to prevent relative movement between stacked paint cans, and the paint saver device 100 is favorably configured to prevent paint-drippage by biasingly covering the paint-can-lid-channel 110 and simultaneously providing stackable vertical storage for the paint cans.

The paint can rim cover 110 is preferably provided as a semi-rigid composite body 107 to provide suitable biasing frictioning means when used to promote positive coupling to the paint can 137; wherein the semi-rigid composite body 107 is further defined by the circular U-shaped cross-section configuration so as to conform to the paint-can-lid-channel 110 and on a rim of the paint can 137. The circular U-shaped cross-section configuration includes the outer-internal-vertical-wall 112 such that the outer-internal-vertical-wall 112 does extend downwardly designed to work with an open paint can 137.

It may further noted that the paint can rim cover 102 may be constructed by an injection molded process; wherein the paint can rim cover 102 may comprise plastic, non-plastic or rubberized material resistant to chemical degradation caused by contact with the paint and may be configured such that the exterior wall drip skirt 134 prevents the paint from dripping down an outside of the paint can 137. In preferred embodiments the thumb release tab 130 has gripping means 139 to include an arcuate profile suitable for gripping by a thumb and forefinger to work in conjunction with the interior bead retainer 128. When coupled it is located below a lip of the rim of the paint can 137 integrally extending outwardly from the exterior wall drip skirt 134.

According to one embodiment, the paint saver device 100 may be arranged as a kit 105. In particular, the paint saver device 100 may further include a set of instructions 155. The instructions 155 may detail functional relationships in relation to the structure of the paint saver device 100 (such that the paint saver device 100 can be used, maintained, or the like, in a preferred manner).

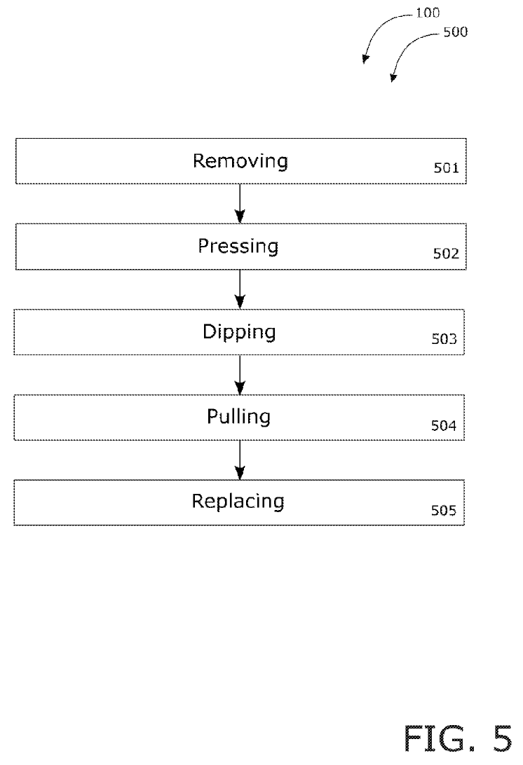

FIG. 5 is a flow diagram illustrating a method for method of use 500 according to an embodiment of the present disclosure. In particular, the method for method of use 500 may include one or more components or features of the paint saver device 100 as described above. As illustrated, the method of use 500 may include the steps of: step one 501, removing a paint can lid, step two 502 pressing the paint saver device onto a top of a paint can 137, step three 503 dipping a paint brush into paint and feathering off excess the paint on paint saver device 100 while preventing the paint from entering a paint-can-lid-channel 110 and step four 504 pulling a thumb release tab 130 and removing the paint saver device 100, and step five replacing the paint can lid. An optional step five 505 may comprise vertically stacking other the paint cans on the paint can.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use for paint can rim cover (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A paint saver device, the paint saver device comprising:
a paint can rim cover including,
a semi-rigid composite body having,
a circular U-shaped cross-section configuration,
an outer-internal-vertical-wall,
an outer-external-vertical-wall,
an external-vertical-wall-extension,
a top-outer-surface,
a top-inner-surface,
an external-vertical-wall-inner-surface,
an internal-vertical-wall-inner-surface,
a peripheral retention barrier,
an interior bead retainer,
an exterior rim engagement lock,
an exterior wall drip skirt, and
a thumb release tab,
wherein said paint saver system comprises said rim cover forming said semi-rigid composite body,
wherein said semi-rigid composite body having said circular U-shaped cross-section configuration is structured and arranged to provide dual purpose retaining means for said paint can rim cover and biasingly fits over and about a paint-can-lid-channel,
wherein parameters of said paint can rim cover are defined via said outer-internal-vertical-wall, said outer-external-vertical-wall, and said top-outer-surface, said top-outer-surface opposing said top-inner-surface,
wherein said outer-internal-vertical-wall includes said internal-vertical-wall-inner-surface having said interior bead retainer, extruded at its lower end,
wherein said outer-external-vertical-wall includes said external-vertical-wall-inner-surface having said exterior rim engagement lock, extruded midway and said external vertical wall extension, extending therefrom,
wherein said external vertical wall, further includes said exterior wall drip skirt, and said thumb release tab, arranged perpendicular and extending outwardly, externally opposing said exterior rim engagement lock,
wherein said thumb release tab is configured to allow for biasing manipulation of said paint can rim cover,
wherein said top-outer-surface includes said peripheral retention barrier, extending vertically and circumferentially about an outer quadrant of said top outer surface, said peripheral retention barrier situated to prevent relative movement between stacked paint cans, and
wherein said paint saver is favorably configured to prevent paint-drippage by biasingly covering said paint-can-lid-channel and simultaneously providing stackable vertical storage for said paint cans.

2. The paint saver devise of claim 1, wherein said paint can rim cover is provided as a semi-rigid composite body to provide suitable biasing frictioning means when used to promote positive coupling to said paint can.

3. The paint saver device of claim 2, wherein said semi-rigid composite body, is further defined by said circular U-shaped cross-section configuration so as to conform to said paint-can-lid-channel and on a rim of said paint can.

4. The paint saver device of claim 3, wherein said circular U-shaped cross-section configuration includes said outer-internal-vertical-wall such that said outer-internal-vertical-wall does extend downwardly designed to work with an open said paint can.

5. The paint saver device of claim 4, wherein said circular U-shaped cross-section configuration includes said outer-internal-vertical-wall for directing paint spillage into said paint can.

6. The paint saver device of claim 5, wherein said circular U-shaped cross-section configuration includes said outer-external-vertical-wall to provide vertical stability for stacked said paint cans.

7. The paint saver device of claim 6, wherein said circular U-shaped cross-section configuration includes said external vertical wall extension

8. The paint saver device of claim 7, wherein said paint can rim cover is injection molded.

9. The paint saver device of claim 8, wherein said paint can rim cover comprises plastic.

10. The paint saver device of claim 9, wherein said paint can rim cover comprises non-plastic.

11. The paint saver device of claim 10, wherein said paint can rim cover comprises rubberized material resistant to chemical degradation caused by contact with said paint.

12. The paint saver device of claim 3, wherein said exterior wall drip skirt prevents said paint from dripping down an outside of said paint can.

13. The paint saver device of claim 12, wherein said thumb release tab has gripping means.

14. The paint saver device of claim 13, wherein said thumb release tab comprises an arcuate profile suitable for gripping by a thumb and forefinger.

15. The paint saver device of claim 14, wherein said interior bead retainer when coupled is located below a lip of said rim of said paint can.

16. The paint saver device of claim 15, wherein said semi-rigid composite body includes a thumb release tab, integrally extending outwardly from said exterior wall drip skirt.

17. A paint saver device, the device comprising:
a paint can rim cover including,
a semi-rigid composite body having,
a circular U-shaped cross-section configuration,
an outer-internal-vertical-wall,
an outer-external-vertical-wall,
an external-vertical-wall-extension,
a top-outer-surface,
a top-inner-surface,
an external-vertical-wall-inner-surface,
an internal-vertical-wall-inner-surface,
a peripheral retention barrier,
an interior bead retainer,
an exterior rim engagement lock,
an exterior wall drip skirt, and
a thumb release tab,
wherein said paint saver system comprises said rim cover forming said semi-rigid composite body,
wherein said semi-rigid composite body having said circular U-shaped cross-section configuration is structured and arranged to provide dual purpose retaining means for said paint can rim cover and biasingly fits over and about a paint-can-lid-channel,
wherein parameters of said paint can rim cover are defined via said outer-internal-vertical-wall, said outer-external-vertical-wall, and said top-outer-surface, said top-outer-surface opposing said top-inner-surface,
wherein said outer-internal-vertical-wall includes said internal-vertical-wall-inner-surface having said interior bead retainer, extruded at its lower end,
wherein said outer-external-vertical-wall includes said external-vertical-wall-inner-surface having said exterior rim engagement lock, extruded midway and said external vertical wall extension, extending therefrom,
wherein said external vertical wall, further includes said exterior wall drip skirt, and said thumb release tab, arranged perpendicular and extending outwardly, externally opposing said exterior rim engagement lock,
wherein said thumb release tab is configured to allow for biasing manipulation of said paint can rim cover,
wherein said top-outer-surface includes said peripheral retention barrier, extending vertically and circumferentially about an outer quadrant of said top outer surface, said peripheral retention barrier situated to prevent relative movement between stacked paint cans,
wherein said paint saver is favorably configured to prevent paint-drippage by biasingly covering said paint-can-lid-channel and simultaneously providing stackable vertical storage for said paint cans,
wherein said semi-rigid composite body, is further defined by said circular U-shaped cross-section configuration so as to conform to said paint-can-lid-channel and on a rim of said paint can,
wherein said circular U-shaped cross-section configuration includes said outer-external-vertical-wall to provide vertical stability for stacked said paint cans, and
wherein said paint can rim cover is provided as a semi-rigid composite body to provide suitable biasing frictioning means when used to promote positive coupling to said paint can.

18. The paint saver device of claim 17, further comprising a set of instructions; and
wherein the paint saver device is arranged as a kit.

19. A method of use for a paint saver device, the method comprising the steps of:
removing a paint can lid,
pressing said paint saver device onto a top of a paint can,
dipping a paint brush into paint and feathering off excess said paint on paint saver device while preventing said paint from entering a paint-can-lid-channel, pulling a thumb release tab and removing said paint saver device, and
replacing said paint can lid.

20. The method of claim 19, further comprising the step of vertically stacking other said paint cans on said paint can.
